(19) United States
(12) Patent Application Publication
(10) Pub. No.: US 2021/0114343 A1
(43) Pub. Date: Apr. 22, 2021

(54) Foam fiber elastomeric materials and their manufacturing

(71) Applicant: Teknologian tutkimuskeskus VTT Oy, Espoo (FI)

(72) Inventors: Riku Pihko, VTT (FI); Oleg Timofeev, VTT (FI); Jukka Ketoja, VTT (FI); Katariina Torvinen, VTT (FI); Kirsi Immonen, VTT (FI)

(21) Appl. No.: 16/464,298

(22) PCT Filed: Nov. 27, 2017
(86) PCT No.: PCT/FI2017/050832

§ 371 Date: May 28, 2019

(30) Foreign Application Priority Data
Nov. 28, 2016 (FI) 20165904

(51) Int. Cl. B32B 5/32; B32B 5/26; B32B 5/24; B32B 5/18; B32B 21/04; B32B 1/08

(52) U.S. Cl. CPC B32B 5/32; B32B 2255/102; B32B 5/245; B32B 5/18; B32B 21/047; B32B 1/08; B32B 2274/00; B32B 2270/00; B32B 2266/0292; B32B 2266/025; B32B 2266/0278; B32B 2266/0264; B32B 2266/0257; B32B 2325/00; B32B 2367/00; B32B 2377/00; B32B 2375/00; B32B 2323/00; B32B 2260/021; B32B 2260/048; B32B 2260/046; B32B 2307/51; B32B 2307/72; B32B 2307/732; B32B 2255/26; B32B 5/26

(57) ABSTRACT

The present invention concerns an elastic fibrous material, based on a fiber network, also including an elastomeric component, which material has been formed into a flat structure with two surfaces. Further, the invention concerns a method of manufacturing said elastic fibrous material by forming a fiber network, containing an elastic polymer, foaming the fiber network, adding it into one or more layers on a support, followed by curing.

### BACKGROUND OF THE INVENTION

### Field of the Invention

The present invention concerns fibrous elastomeric materials suitable for use e.g. in padding for furniture, panels, shoes, pillows and mattresses or in providing insulation materials, covering pipes and other similar surfaces, with moisture resistance.

Further, the invention concerns a process for manufacturing said padding and insulation products from such materials.

### Description of Related Art

Elastomeric paddings are needed in furniture, panels, shoes, pillows and mattresses. Moreover, elastomeric insulation materials are used for the insulation of pipes, and other curved surfaces, demanding moisture resistance.

Particularly air conditioning pipes have high requirements, due to the condensation of moisture to the pipes, which needs to be prevented.

In addition to insulation, other requirements of such products are strength and elasticity. The required strength would be possible to achieve using fibers. Suitable additives also exist that can render a fibrous material impermeable. However, the flexibility and elasticity required in order to maintain this strength and the impermeability of the product also in corners, or at the points where pipes are bent, is not obtained using these fibrous products. Therefore, it is necessary to find alternative or improved solutions.

Rubber has been used as an insulation material, due to its elasticity and impermeability. A common method used to produce the existing elastomerics is based on mixing said rubber and a foaming agent, and extruding these to produce the elastomeric insulation material.

However, the price of rubber is higher than that of natural fibres, and rubber exists in only limited supply. Further, in case of fire, rubber produces lots of toxic gases.

Therefore, there is a continuing demand for replacing solutions, particularly for alternative systems providing flexibility, while limiting the need for rubber.

Adding elastic fibers or fines into a fiber network has been attempted in order to produce elastic products, such as in GB 1118221, describing a cellulose composite including a binder that can be selected from rubber latex binders. However, the achieved improvements in elasticity have been minor.

WO2003089506, in turn, describes interpenetrating networks of polymer chains comprising primary polymers and strengthening polymers, which impart significantly enhanced mechanical strength and elasticity to a hydrogel. Suitable strengthening agents that can be used for the product of the reference include natural and synthetic polymers, polyelectrolytes, as well as neutral hydrophilic polymers. The reference thus used polymers for strengthening the product, but these do not provide increased flexibility.

WO 2014011112 A1 describes a hydrophobized nanofibrillated cellulose foam comprising a charged hydrophobic amine. In compression tests, deformation is linearly elastic at low stresses, but for large strains cell collapse and foam densification are observed.

Similarly, Kato et al. (2015) relates to a rubber-fiber material, but with the rubber and the fiber being crosslinked in a manner providing reinforcement by the fiber, instead of causing an increased elasticity.

As a conclusion, the known insulation technology is more focused on lightweighting and reinforcement than on elasticity.

Therefore, there is still a need for fibrous insulation and padding products with improved elasticity.

### SUMMARY OF THE INVENTION

It is an aim of the invention to eliminate at least some of the problems of the prior art and to provide fiber-based products having a sufficient elasticity to allow shaping of the material into a desired form while maintaining a uniform surface, as well as insulation and padding properties.

Thus, according to a first aspect of the present invention, there is provided an elastic fibrous material, based on a fiber network, also including an elastomeric component, consisting of one or more elastomers selected from unsaturated rubber and thermoplastic elastomers, which material has been formed into a flat structure with two surfaces, optionally shaped into a tube.

According to a second aspect of the present invention, there is provided a method for manufacturing said elastic fibrous material.

According to a third aspect of the invention, there is provided the use of the material in insulation for refrigeration piping, hot and cold water lines, chilled water piping, air conditioning (HVAC) components, interior and exterior duct systems, chillers, mechanical systems for industrial, pharmaceutical and marine and offshore applications, as well as for solar installations.

According to a fourth aspect of the invention, there is provided the use of the material as padding to furniture, panels, shoes, pillows and mattresses.

The invention is based on the finding that elastic fiber networks based on natural raw materials, such as wood or hemp, flax, cotton, sisal, kenaf, straw fibers and husks, can be prepared by foam forming when an elastic polymer component is added to the fiber network.

Thus, the present invention concerns a foam-formed fiber network prepared from natural fibers cross-linked with elastic polymers, e.g. natural rubber, with sulphur as a cross-linking agent.

Elasticity is a property determined by the capability of a material to return to its original shape after deformation. It also means that a material can be shaped and bent without cracking its surface.

Elastomeric insulation materials are therefore used for moisture resistance demanding insulation of pipes, and other similar surfaces. Elasticity is generally not found among natural fibers. However, the price of known elastomeric insulation materials is high, compared to the presently used fibers, and in case of fire they produce toxic gases.

The present new foam fiber elastomeric contains fibers and rubber and forms good moisture resistance and insulation properties with much less production costs, compared to the existing materials. Due to the use of fiber there are less toxic gases produced in case of fire.

The new foam fiber elastomeric material can be produced in a profitable continuous way by applying a casting and metal belt, as well as impingement heating and drying.

Thus, the invention provides several advantages compared to prior rubber elastomers, including a lower manufacturing cost, as well as an increased safety. These advantages are caused by the significantly lower amount of rubber that is required in manufacturing these insulation materials, as rubber is an expensive raw-material that releases toxic gases in case of fire.

The novel elastic materials of the invention can also be produced using a simple method that can be carried out using existing equipment.

### BRIEF DESCRIPTION OF THE DRAWINGS

FIG. 1 is a schematic drawing of an example apparatus capable of producing the product according to at least some embodiments of the present invention.

FIG. 2 illustrates the possible shapes of the final product in accordance with at least some embodiments of the invention, with FIG. 2A showing a tubular product, and FIG. 2B showing a flat product, which, optionally, can be layered.

FIG. 3 illustrates the recovered thickness of a foam-formed chemi-thermo-mechanical (CTMP) fibre network with varied amounts of natural rubber latex 30 s after the compression to different levels (e.g. 70% corresponds to 30% of the original height), where cross-linking prevents self-adhesion of rubber latex at 90% compression level.

FIG. 4 illustrates the recovery of the sample shape after compression to 10% of the original height for a CTMP fibre network including about 20% of natural rubber (left) and a similar network without the rubber latex (right).

FIG. 5 is an X-ray tomographic image showing the distribution of a natural rubber latex in a CTMP fibre network.

### EMBODIMENTS OF THE INVENTION

### Definitions

In the present context, the term “fibrous” product is intended to cover products that include at least one layer containing at least 50% by weight fiber, preferably selected from wood fibers, most suitably cellulose fibers.
The term “unsaturated rubber” refers to rubber grades that can be cured by sulphur vulcanization, including natural and synthetic polyisoprene rubber, butadiene rubber, chloroprene rubber, butyl rubber, styrene-butadiene rubber and nitrile rubber. Preferably the rubber is selected from natural rubbers.
The term “thermoplastic elastomer” (TPE), in turn, refers to styrenic block copolymers, thermoplastic olefins, thermoplastic polyurethanes, thermoplastic copolyester and thermoplastic polyamides. These elastomers typically consist of blends of polymers, preferably including rubber. In case of thermoplastic olefins, they preferably contain polypropylene or polyethylene.

The present invention concerns a fibrous and elastomeric material, which obtains its high strength from its fibrous component, and its elasticity from its elastomeric component.

In this product, the required strength and low density is obtained using fibers, i.e. the fibrous component. Suitable fibers include wood fibers, nanocellulose and hemp. Preferably, chemi-thermomechanical pulp (CTMP), chemical pulp or hemp is used, most suitably CTMP.

Further, the required elasticity is obtained using elastomeric polymers, selected from the unsaturated rubbers listed above, or from alternative elastomers, such as thermoplastic elastomers (TPE), resilin or elastin proteins, or elastolefin (elastic fiber).

Moisture resistance is obtained using (rubber) latex, preferably sprayed onto the surface of the product.

According to an embodiment of the invention, natural rubber is used as an elastomeric polymer, optionally mixed with one or more other polymers.

Typically, the total ratio by weight of the fiber to elastomeric component, in the elastic fibrous material, is 50:50-90:10.

For elastic paddings, the fibrous component and the elastomeric component are mixed together so that the elastomeric component helps the recovery of the fibrous network structure after material deformations.

According to a preferred embodiment for insulation purposes, the fibrous component and the elastomeric component are added at least to a major part into different layers, optionally glued together using conventional binding agents.

Particularly, the product of the invention includes one or more layer(s) containing mainly fibers as well as some elastic component, preferably containing 80% or more of fiber, and one or more layer(s) containing mainly elastic component as well as some fibers, preferably containing 50% or more of elastomeric polymer.

Thus, the ratio of fiber/elastics typically varies in different layers of the product, while the different layers differ from each other mainly in terms of said ratios.

The present invention also relates to a process for producing such an elastomeric material. In the process, the fibers and the elastomer are spread into a sheet, having a thickness that can vary, preferably being 10-50 mm. Optionally, different layers are formed, with varying ratios of fiber/elastomer. Typically, sulphur (e.g. as a powder) is added to cause cross-linking.

Suitable production techniques include casting, spraying, extrusion and molding, typically followed by heating and drying.

Drying can include vacuum enhanced water removal combined with hot air and/or a heated fabric or belt.

Preferably, foam forming is used, since this procedure provides a low-density porous fiber network that is capable of recovering its porosity (the final product having more “spherical” pores instead of “horizontal” pores, the latter being more easily flattened by pressing). Naturally, also the elasticity of the polymer has an effect on the porosity of the product, as well as the properties of the fibers (such as fiber length and rigidity, with hemp having particularly long fibers).

Advantageously, production of flat products include the following steps:
1) Main fiber structure forming including a step of arranging at least part of the fibers in z direction to improve bulk,
2) Drying of main fiber structure,
3) Addition of elastomeric polymer, optionally a material enhancing moisture resistant properties,
4) Curing and drying of the final structure,
5) Reeling of the final structure,
6) Possible further processing.

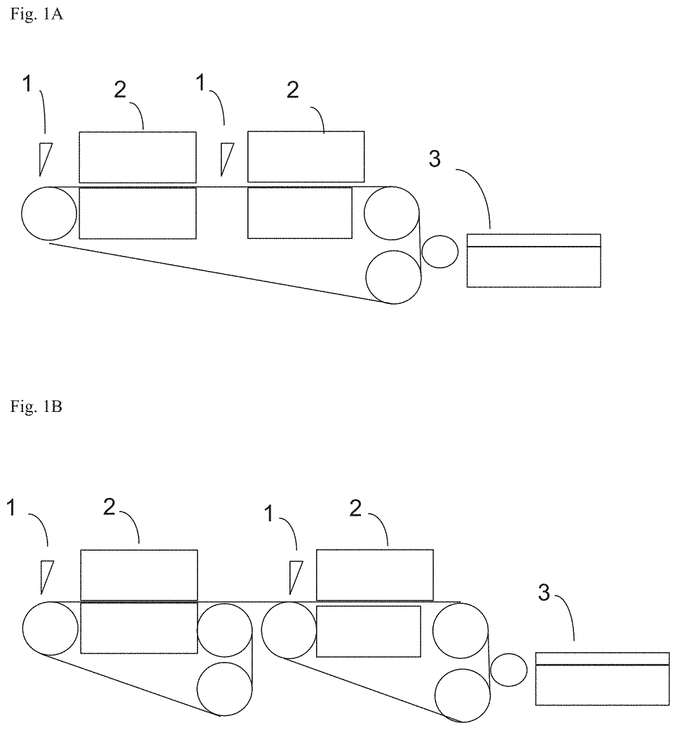

These flat products are typically produced on a continuous line, e.g. as in FIGS. 1A and B, where the following sections of a suitable production apparatus are shown, in accordance with an embodiment of the invention:
1 Caster, Extruder or Sprayer
2 Heater and Dryer
3 Reeler

According to a preferred embodiment (as seen in said FIGS. 1A and B), the apparatus includes more than one caster or extruder 1 and more than one dryer 2, whereby several layers or several materials can be processed in separate steps.

The consistency of the fibers during the casting or beginning of forming is 1-10%, typically 2-4%.

The air content of the foam is 40-80%, typically 50-70%.

The elastomeric polymer typically requires a high temperature to cause curing. Thereby, preferably, a temperature of 130-150° C. is used to ensure sufficient hardening.

The fibers and the elastomeric polymer are typically combined in wet foam or immediately before the curing step in order to cause some absorption or impregnation of the polymer into the fibrous layer, without complete mixing.

According to one option, the elastomeric components is/are added as a dispersion.

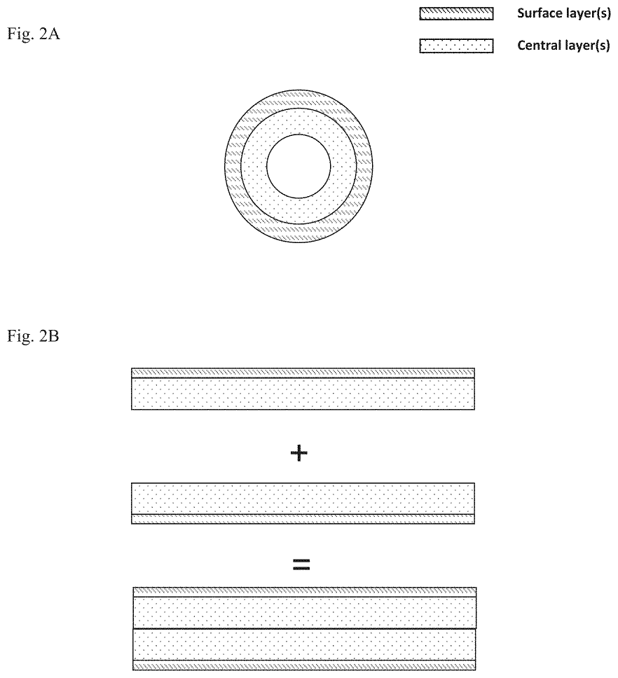

The product can be formed into a flat structure, or shaped as a tube (see FIG. 2). Particularly it is formed to include one or more central layer(s) (see the dotted layers of FIG. 2), which preferably contain mainly fibers as well as some elastic component, and one or more surface layer(s) (see the layers marked with diagonal lines in FIG. 2), which preferably are formed of a foam containing mainly elastic component as well as fibers.

Thus, the ratio of fiber/elastics typically varies in different layers of the product.

The layered flat structure is preferably formed to give a total thickness of 10-50 mm, while thinner and thicker structures are also possible.

As seen in FIG. 2B, the product can include more than one central layer and more than one surface layer, whereby gluing preferably is used to combine the layers.

The obtained product can be used especially for padding in furniture, panels, shoes, pillows and mattresses or for refrigeration piping, hot and cold water lines, chilled water piping, air conditioning (HVAC) components, interior and exterior duct systems, chillers, mechanical systems for industrial, pharmaceutical and marine and offshore applications, as well as for solar installations.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Furthermore, the described features, structures, or characteristics may be combined in any suitable manner in one or more embodiments. In this description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc.

Reference throughout this specification to an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

While the examples described herein are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

Thus, the following non-limiting examples are intended merely to illustrate the advantages obtained with the embodiments of the present invention.

### Examples

When testing fibrous materials under external load, the material stresses concentrate especially on the fiber joints, causing plastic changes in the fiber wall. After removing the load, the fiber network does not recover its original state.

In the present invention, an elastic polymer support is created in the fiber joint region, which causes a spring-back of the fiber network and the recovery of strain after the external load is removed.

This has been demonstrated in a model system consisting of CTMP fibers and a polymer system consisting of natural rubber optionally cross-linked at high temperature (>140° C.) with sulphur.

The fiber network with quite low density (c.a. 20-30 kg/m³) was prepared using foam forming with latex amounts varying in the range 20-30%.

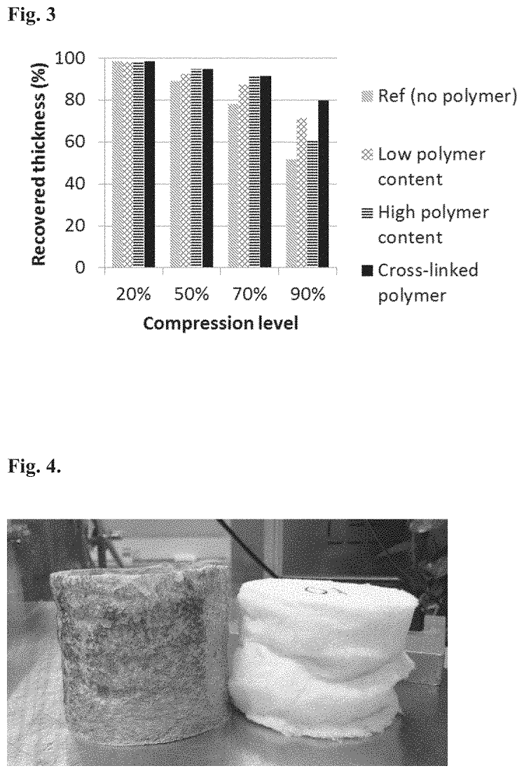

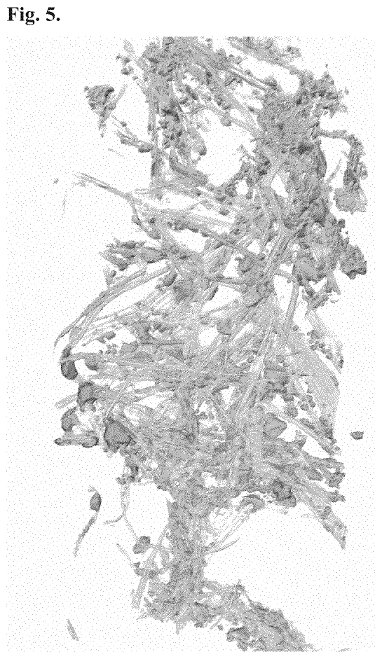

The immediate elastic recovery of the very large compression (30% of the original size) is ca 80-85% with very fast (a few seconds) creep recovery up to ca 90-95%, see FIGS. 3 and 4. These levels are clearly higher than the values found for any previous similar fibre networks. FIG. 5 shows how the rubber latex covers fibre joints helping the recovery of the structure after deformation.

### INDUSTRIAL APPLICABILITY

The present material can be used as insulation for various pipes and other surfaces, in particular to provide heat and moisture resistance for refrigeration piping, hot and cold water lines, chilled water piping, air conditioning (HVAC) components, interior and exterior duct systems, chillers, mechanical systems for industrial, pharmaceutical and marine and offshore applications, as well as for solar installations. Additionally these materials can be applied as padding to furniture, panels, shoes, pillows and mattresses.

### REFERENCE SIGNS LIST

1 Caster, extruder or sprayer
2 Heater or dryer
3 Reeler

### CITATION LIST

### Patent Literature

GB1118221
WO2003089506
WO 2014011112 A1

### Non-Patent Literature

Kato H., Nakatsubo F., Abe K., Yano H., RSC Adv., 2015, 5, 29814-29819

1. An elastic fibrous material comprising:
one or more foamed fiber-based layers comprising at least 80% by weight of fibers and optionally further comprising an elastomeric polymer, and
one or more foamed elastomeric layers comprising at least 50% by weight of the elastomeric polymer and optionally further comprising the fibers,
wherein the elastomeric polymer is selected from unsaturated rubber or a thermoplastic elastomer, and
wherein the layers have been cured and formed into a flat structure or a tube with two surfaces, wherein the two surfaces comprise an inner surface and an outer surface.

2. The elastic fibrous material of claim 1, wherein the fibers are selected from the group consisting of wood fibers, nanocellulose and hemp.

3. The elastic fibrous material of claim 1, wherein the elastomeric polymer comprises unsaturated rubber, and wherein the unsaturated rubber is selected from the group consisting of natural and synthetic polyisoprene rubber, butadiene rubber, chloroprene rubber, butyl rubber, styrene-butadiene rubber, and nitrile rubber.

4. The elastic fibrous material of claim 1, wherein the elastomeric polymer comprises a thermoplastic elastomer, and wherein the thermoplastic elastomer is selected from the group consisting of styrenic block copolymers, thermoplastic olefins, thermoplastic polyurethanes, thermoplastic copolyester, and thermoplastic polyamides.

5. The elastic fibrous material of claim 1, wherein a total ratio by weight of the fiber to elastomeric component in the elastic fibrous material is 50:50-90:10.

6. (canceled)

7. The elastic fibrous material of claim 1, further comprising a latex layer on the surface of the elastic fibrous material.

8. The elastic fibrous material of claim 1, further comprising one or more layers formed of the fiber network, optionally containing some elastomeric component, and one or more layers of elastomeric component, optionally containing some fibers.

9. A method of manufacturing an elastic fibrous material comprising: forming a fiber network, optionally with an elastic polymer, foaming the fiber network, adding the foamed fiber network as a layer on a substrate, combining the foamed fiber layer with a foamed elastomeric layer, optionally containing fibers, and heating the foamed fiber layer and foamed elastomeric layer to produce a cured material.

10. The method of claim 9, wherein the fiber network is added as a layer having a wet consistency of 1-10% as a foamed dispersion.

11. The method of claim 9, wherein the elastomeric is added as a layer or mixed in fibre suspension having a wet consistency of 20-70% as a foamed dispersion.

12. (canceled)

13. The method of claim 9, wherein sulfur sulphur, preferably as a powder, is added into the foamed fiber network as a crosslinking agent.

14. The method of claim 9, wherein the foamed fiber and foamed elastomeric layers are heated to a temperature of 130-150° C. to produce the cured material.

15. The method of claim 9, wherein latex is sprayed onto the cured material to seal any remaining openings on the cured material.

16. (canceled)

17. The method of claim 2, wherein the fibers comprise chemi-thermomechanical pulp (CTMP).
